(19) United States
(12) Patent Application Publication
(10) Pub. No.: US 2010/0207770 A1
(43) Pub. Date: Aug. 19, 2010

(54) Alarm system for photovoltaic modules as well as method for protecting a photovoltaic installation from theft

(75) Inventor: Christian Thiemann, Frankfurt (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: SCHOTT SOLAR AG

(21) Appl. No.: 12/696,888

(22) Filed: Jan. 29, 2010

(30) Foreign Application Priority Data
Jan. 30, 2009 (DE) 10 2009 006 999.2

(51) Int. Cl. G08B 17/12

(52) U.S. Cl. 340/600

(57) ABSTRACT

An alarm system for photovoltaic modules is provided that includes an alarm installation electrically connected to at least one photovoltaic module. The alarm installation is connected via a power connection line to the at least one photovoltaic module and the alarm installation has a device to read out a pulse response of the at least one photovoltaic module.

### FIELD OF THE INVENTION

The invention relates to an alarm system for photovoltaic modules as well as a method for protecting a photovoltaic installation from theft.

### BACKGROUND OF THE INVENTION

Photovoltaic installations containing solar cells are known. As a rule, these involve installations which are constructed from modules. The modules containing solar cells are usually connected to a power supply device, by means of which the electrical current generated by the solar cells, transformed into an a.c. voltage of suitable level, can be fed into the power supply network. These types of installations have achieved a widespread use in recent years, primarily based on regulatory requirements, and find use not only on the roofs of residences and office buildings, but increasingly also in more widely distributed sites, such as outdoors.

The construction of a photovoltaic installation is associated with high investment costs; high-quality photovoltaic modules are a particularly high cost factor.

Therefore, there are increasing thefts of photovoltaic modules. In fact, mounting means that make difficult the theft of solar modules can be obtained on the market. It is particularly known to use screws, in which, for example, a part of the head breaks off after the screw has been screwed in, so that the screw can no longer be removed with common tools. These types of theft protection means, however, only lead to making a theft difficult, which does not play a large role, particularly outdoors, since the thief has sufficient time available.

In addition, it is known to provide solar modules with serial numbers, in order to be able to again recognize stolen solar modules. This type of security, however, has limited deterrent effect.

Alarm installations known from security technology can only be implemented for the most part with high expenditure in a photovoltaic installation. Known wired alarm installations would require a switch on each individual solar module. A wireless monitoring, e.g., by means of a transponder, is generally very complex and expensive.

Document DE 20 2007 011 806 U1 shows an alarm installation for photovoltaic modules, in which memory modules that bear an identification code are connected to the alarm installation via a bus. For this purpose, memory modules in which an individual identification code is filed, are necessary, for use in photovoltaic modules. The system is therefore complicated and cannot be implemented later or into an existing photovoltaic installation or can be implemented only with very high expenditure.

### OBJECT OF THE INVENTION

Against this background, the object of the invention is to create an alarm system for photovoltaic modules, which can be constructed in a reliable, simple and cost-effective manner.

In particular, an object of the invention is to include already existing components of a photovoltaic installation in an alarm system, without anything further.

Another object of the invention is to provide an alarm system, which can be retrofitted in a particularly simple way in already installed photovoltaic installations.

### SUMMARY OF THE INVENTION

The object of the invention is achieved by an alarm system for photovoltaic modules as well as by a method for protecting a photovoltaic installation from theft according to one of the independent claims.

Preferred embodiments and enhancements of the invention can be taken from the respective subclaims.

On the one hand, the invention relates to an alarm system for photovoltaic modules in which an alarm installation is electrically connected to at least one photovoltaic module.

A particularly simple monitoring of photovoltaic modules is possible by means of an electrical connection via an existing power connection line, without anything further.

For example, in the case of an interruption of the electrical circuit, an alarm signal can be generated via the alarm installation.

The generation of alarm signals is known. In the sense of the invention, for example, an alarm siren can be turned on, and/or the alarm can be conveyed, for example, to a monitoring company. In addition, wireless technologies such as GSM or UTMS can be employed to convey the alarm signal for alarm installations installed outdoors.

According to the invention, the pulse response of a photovoltaic module or a group of photovoltaic modules will be used as identification.

For the most part, active and/or passive components are present in the photovoltaic modules, without anything further.

A characteristic pulse response is generated by existing diodes, bypass diodes, solar cells and/or transistors, in particular.

The utilization of these existing components, which are provided for the distribution and/or transformation of the current generated by the photovoltaic modules, without anything further, makes it possible to provide an alarm system, which can be incorporated later into an existing photovoltaic installation without needing to make changes in the photovoltaic modules themselves.

Thus, for example, the alarm system can be connected to the lines of a power supply device. The pulse response of the photovoltaic installation will be read out in a programming mode and filed in a memory. In the sharply adjusted mode, the alarm system regularly checks the pulse response of the photovoltaic installation, which is based on a plurality of modules. Now, if a single photovoltaic module is removed, the pulse response of the entire installation changes, which is recognized by the alarm system and an alarm will be triggered.

Passive components such as inductances and capacitors make possible a simple change or an amplification of the pulse response. Therefore, in one embodiment of the invention, a plurality of identifications can be attained by the incorporation of various passive components in different photovoltaic modules. Also, in newly manufactured photovoltaic modules, additional electrical components can be provided, which have no function in the generation or distribution of the electrical current produced, but which amplify the pulse response and thus contribute to a better readability of the pulse response.

The pulse response can be read out, for example, via a signal fed into the power connection line.

The electrical or electronic components in the photovoltaic module are preferably laminated into the module, which leads to the circumstance that a removal would lead to a disturbance of the photovoltaic module. Therefore, it is not possible for a thief to remove the electrical components by means of which the identification is finally defined and thus to bypass the connection of the solar module.

It is particularly not possible, since the pulse response is also characterized by components that are necessary for the operation of the photovoltaic module.

In a preferred embodiment of the invention, the alarm installation is integrated into a power supply device. Therefore, a particularly simple implementation of the alarm installation in the photovoltaic installation is possible.

The alarm system preferably comprises a plurality of photovoltaic modules or a plurality of photovoltaic module groups, which are provided with one identification that can be read out for the alarm installation. In particular, when the pulse response is read out, the photovoltaic modules in the sense of the invention can thus also be assembled as groups, whereby, for example, when one photovoltaic module is read out, the pulse response of the photovoltaic module group to which the photovoltaic module belongs changes.

In a preferred embodiment of the invention, the alarm installation comprises a memory, in which a plurality of identifications for photovoltaic modules or photovoltaic module groups can be stored.

The invention in addition relates to a method for protecting a photovoltaic installation from theft.

In this case, an identification, which is assigned to at least one photovoltaic module or a group of photovoltaic modules, is read out repeatedly. A repeated read-out is understood to be a regular or irregular read-out, so that at least temporarily a continuous monitoring of the photovoltaic modules is assured. The time intervals between the read-outs are short, so that it is not possible for a thief to take apart and remove a module in the pause between read-outs.

If an identification cannot be read out or if it has been changed, an alarm signal is generated in the known way by the alarm installation.

A pulse response will be read out as the identification. In one embodiment of the invention, the alarm system is later implemented in an already existing photovoltaic installation.

In a preferred embodiment of the method, the alarm installation used for the method is placed in a programming mode, in which it automatically stores the identification of at least one photovoltaic module.

### BRIEF DESCRIPTION OF THE DRAWINGS

The invention will be explained in the following in more detail with reference to FIG. 1 and FIG. 2 of the drawings.

FIG. 1 shows schematically an alarm system for a photovoltaic installation,

FIG. 2 shows a schematic block diagram of a method for protecting a photovoltaic installation from theft.

FIGS. 3 to 5 show different examples of pulse responses.

### DETAILED DESCRIPTION OF THE DRAWINGS

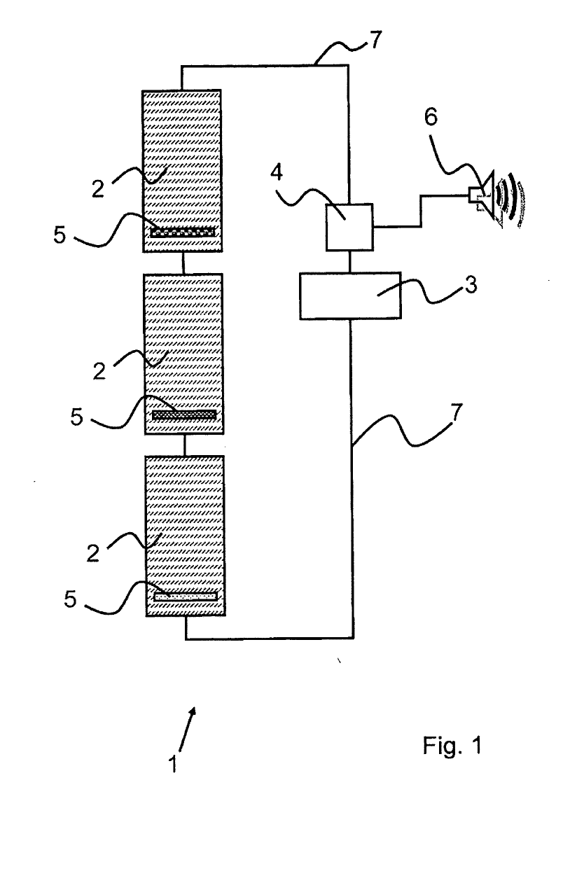

An example of embodiment of an alarm system 1 for photovoltaic modules 2 will be explained schematically in more detail with reference to FIG. 1.

In this example of embodiment, a series of three photovoltaic modules 2 is shown schematically; the modules are electrically connected in series and are connected to a power supply device 3 via power connection lines 7. The electrical current generated by the photovoltaic modules 2 is transformed in the known way via the power supply device 3 and fed into the network (not shown).

Alarm system 1 additionally comprises an alarm installation 4, which in this example of embodiment is connected to a siren 6 for generating an alarm.

In the simplest case, a control circuit could be maintained by the alarm installation 4, and when there is an interruption in the circuit, an alarm is generated.

In this example of embodiment, the alarm installation 4 is also connected, however, to the photovoltaic modules 2 via the power connection lines 7.

In order to assure a monitoring, each photovoltaic module 2 provides an electrical and particularly an electronic component 5, which has an individual identification. The individual identification can also be provided by an electronic component in the form of an integrated circuit.

Preferably, however, at least passive and/or active components are also used, which are simultaneously provided for the function of the photovoltaic module 2, such as, for example, diodes, bypass diodes or solar cells.

A recurring signal is generated via the alarm installation 4, which is fed into the power connection lines 7 and whose pulse response is read out by the alarm installation 4.

As soon as one of the solar modules is removed, the pulse response of the photovoltaic modules 5 connected in series changes, even if the thief bypasses the missing photovoltaic module.

This removal is recognized by the alarm installation 4, in which the reference signal, i.e., the pulse response including all photovoltaic modules 2, is stored and then an alarm signal is generated, which at least triggers siren 6.

Only three photovoltaic modules 5 connected in series are shown in this example of embodiment. It is understood that a photovoltaic installation usually provides several groups of photovoltaic modules connected in series.

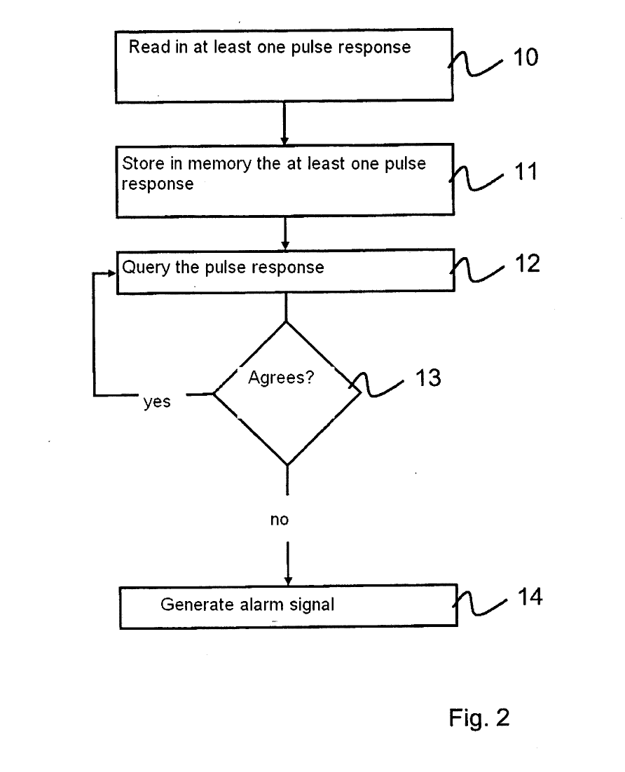

Referring to FIG. 2, the essential steps of one example of embodiment of a method for protecting a photovoltaic installation from theft will be explained in more detail.

According to this method, at least one pulse response of a photovoltaic module or a group of photovoltaic modules is read in at reference 10.

The read-in pulse response is stored by the alarm installation at reference 11. This is preferably conducted in a programming mode.

During operation, the pulse response which is stored is repeatedly queried at reference 12. For this purpose, for example, the alarm installation generates an electrical signal, whose pulse is received.

If the queried pulse response agrees with the stored pulse response 13, the pulse response is again queried at reference 12 after a short pause that varies in length.

If the pulse response does not agree with the stored response, it can be concluded therefrom that something has changed in the arrangement of the photovoltaic modules. It can be recognized from this, for example, that a photovoltaic module has been removed and an alarm signal is generated at reference 14.

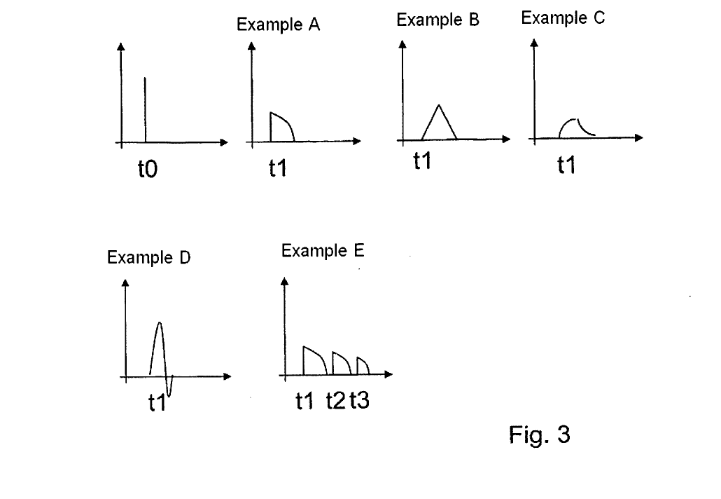

Referring to FIG. 3, the pulse responses of different electronic circuits shall be illustrated. At a time point t₀, a pulse signal is sent to the solar module or to a group of solar modules. A pulse response can be measured at time point t₁ (Examples A to D). Examples A to D show different pulse responses, which can be distinguished on the basis of a characteristic signal.

Example E shows a periodic repeat of a pulse response. Like an echo, a characteristic pulse response occurs at the time points t₁, t₂ and t₃ that are shown.

Such a periodic pulse response is particularly suitable for keeping separate a large number of solar modules, in which a characteristic pulse response is assigned to each solar module.

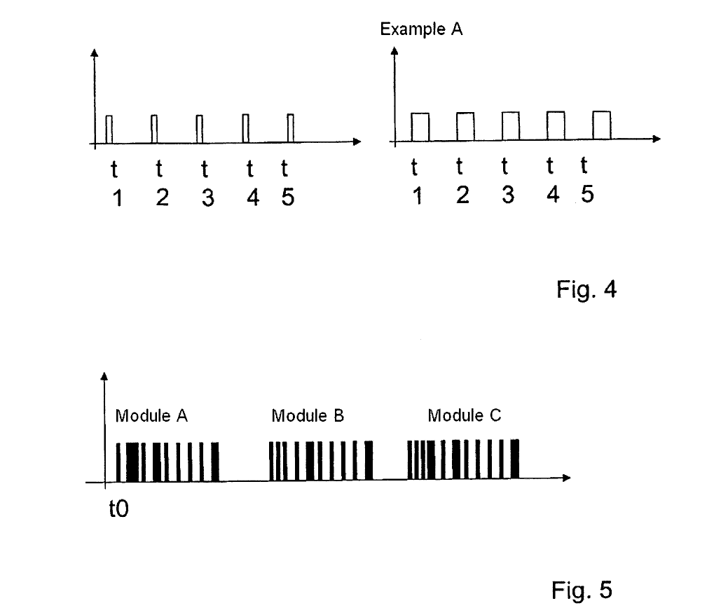

Referring to FIG. 4, another example of a simple theft protection for a solar module will be explained.

On the right in the graph is shown a regular transmission signal, which is periodically emitted at times t₁ to t₅.

On the left in the graph is plotted the regular pulse response, which is shown here in the form of a rectangular signal. Therefore, a continuous theft protection is possible. If a solar module is removed, this removal can be concluded on the basis of the missing rectangular signal and an alarm can be triggered.

Referring to FIG. 5, an alternative embodiment of the invention is presented, in which an individual digital code is additionally assigned to the modules. For this, the modules possess an electronic circuit, which emits a characteristic digital code on the basis of which each module connected thereto can be identified, as a response to a transmission signal (not shown).

The invention makes possible a particularly simple and reliable implementation of an alarm system in a photovoltaic installation.

It is understood that the subject of the invention is not limited to one combination of the above-described features, but rather that the person skilled in the art will combine all features, as long as this is meaningful.

### LIST OF REFERENCE SYMBOLS

1 Alarm system

2 Solar module

3 Power supply device

4 Alarm installation

5 Electrical component

6 Siren

7 Power connection line

10 Reading in a pulse response

11 Storing a pulse response

12 Querying a pulse response

13 Checking agreement

14 Generating alarm signal

1-15. (canceled)

16. An alarm system for photovoltaic modules, comprising:
at least one photovoltaic module;
an alarm installation electrically connected to the at least one photovoltaic module via a power connection line; and
a pulse response reading device configured to read out a pulse response of the at least one photovoltaic module.

17. The alarm system according to claim 16, further comprising a comparison device configured to compare a stored pulse response with the pulse response read out by the pulse response reading device, wherein the alarm installation is configured to generate an alarm when the stored pulse response differs from the pulse response read out by the pulse response reading device.

18. The alarm system according to claim 16, wherein the pulse response read out by the pulse response reading device is at least partially based on an electrical component of the at least one photovoltaic module, wherein the electrical component is a functional component for generation and/or distribution of electrical current.

19. The alarm system according to claim 16, wherein the at least one photovoltaic module comprises an electrical component that can be read out for the alarm installation.

20. The alarm system according claim 19, wherein the electrical component is laminated into the at least one photovoltaic module.

21. The alarm system according to claim 16, wherein the at least one photovoltaic module comprises a plurality of photovoltaic modules each assigned a different identification.

22. The alarm system according to claim 21, further comprising a memory, in which the different identification of each of the plurality of photovoltaic modules is stored.

23. The alarm system according to claim 21, wherein the pulse response reading device is configured to read out the pulse response of the plurality of photovoltaic modules.

24. The alarm system according claim 16, further comprising a power supply device connected to the alarm installation.

25. The alarm system according claim 16, wherein the alarm installation is integrated in a power supply device.

26. The alarm system according to claim 16, wherein the at least one photovoltaic module comprises plurality of photovoltaic module groups each having one or more photovoltaic module, wherein each of the plurality of photovoltaic groups is assigned a different identification and wherein the pulse response reading device is configured to read out the pulse response of the plurality of photovoltaic groups.

27. A method for protecting a photovoltaic installation from theft, comprising the steps of:
reading out of a pulse response of at least one photovoltaic module; and
generating an alarm signal if the pulse response differs from a stored pulse response.

28. The method according to claim 27, wherein the pulse response based at least partially on an electrical unit of the at least one photovoltaic module.

29. The method according to claim 27, wherein the step of reading out of the pulse response of the at least one photovoltaic module comprises reading out the pulse response of a group of photovoltaic modules.

30. The method according to claim 27, further comprising:
setting an alarm installation in a programming mode; and
automatically storing an identification of the at least one photovoltaic module.
